(19) United States
(12) Patent Application Publication
(10) Pub. No.: US 2006/0272439 A1
(43) Pub. Date: Dec. 7, 2006

(54) Gearing

(75) Inventor: Torsten Wahler, Bad Durrheim (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS AKTIENGESELLSCHAFT, Munich (DE)

(21) Appl. No.: 10/537,905

(22) PCT Filed: Dec. 8, 2003
(86) PCT No.: PCT/DE03/04035

§ 371 Date: May 30, 2006

(30) Foreign Application Priority Data
Dec. 12, 2002 (DE) 102 58 188.6

(51) Int. Cl. F16H 55/08

(52) U.S. Cl. 74/457

(57) ABSTRACT

The invention relates to a gearing comprising: an internal gear (1); a flexible toothed band (2) that runs inside the internal gear and has fewer teeth than the internal gear (1), and; a rotatable wave generator (3), which transmits a force to the toothed band (2) via a tappet gear (4). A relative motion of the toothed band (2) with regard to the internal gear (1) results from the rotation of the wave generator (3). The inventive gearing is characterized in that a mating gear (7) is provided, and driving pins (5) are shaped on a lateral face of the toothed band (2) that engage inside recesses (6) of the mating gear (7). The inventive gearing is provided with a particularly simple design and has a very low overall height.

The invention relates to a gearing comprising a fixed, internally toothed internal gear, an annular, flexible toothed band, which is engaged with the toothing of the internal gear, the toothed band having fewer teeth than the internal gear, and a rotatable wave generator, which transmits a force to the toothed band via a tappet gear, a relative motion of the toothed band with respect to the internal gear resulting from a rotation of the wave generator.

Such gearings are known as “harmonic drive”. The basis for the realization of the working principle is a deformable toothed band, also referred to as a flex ring, which is driven by the wave generator and the non-circular shape of which latter is transmitted to the flex ring via the tappet gear. The cross section through the wave generator is preferably elliptical. If the wave generator is driven, a transverse wave is generated, which is supported against the internal gear. The rotation speed conversion is determined by the difference in the number of teeth between the internal gear and the flex ring. Since this difference is very small, very high transmission ratios can be achieved, in particular from 1:50 up to 1:5000.

The advantage of this gearing principle is the very flat construction, combined with a low number of parts.

Another gearing which allows such transmission ratios is a multistep planetary gearing. Multistep planetary gearings are relatively complex, however, and require a large number of parts, leading to increased manufacturing costs.

In addition thereto, worm gearings are known, which, though also allowing a relatively high transmission ratio, have only a low efficiency. In many applications, the use of worm gearings is therefore precluded.

In the case of the “harmonic drive” gearings mentioned in the introduction, the problem exists of how the motion of the toothed band is relayed. In this context, two embodiments are hitherto known, which are referred to as a flexible cup gearing and as a flat gearing. Whereas, in a flexible cup gearing, the power take-off is effected directly via the flex ring, in the case of the flat gearing a second internal gear is required, which possesses the same number of teeth as the flex ring. The disadvantage of the flexible cup gearing consists in the high spatial requirement, while, in the case of the flat gearing, the toothing has to be specially adapted, in addition to which, a larger structural space is also necessary to realize the coupling step.

The object of the invention is to define a gearing which, even with the incorporation of the force relay mechanism, requires a very low structural space and, moreover, is simple in structure.

This object is achieved by a gearing of the type stated in the introduction, which is characterized in that a mating gear is provided and driving pins are shaped on a lateral face of the toothed band, which engage in recesses in the mating gear.

The advantage of the inventive configuration of the gearing consists in the very flat construction, without the need for a large number of parts. Compared to the abovementioned flat gearing, the advantage exists that it is possible to dispense with a second internal gear for use as a coupling element. Instead, a simply constructed mating gear is used, which is substantially cheaper. In a very simple embodiment, the mating gear can be disk-shaped with radially disposed grooves in which the driving pins engage. Since the torque is always transmitted via a plurality of pins, even high torques can be transmitted. Any chosen mechanical elements can be shaped on or fitted onto the mating gear in order to relay the torque, in particular the mating gear can be connected to gearwheels, rigid or flexible shafts, clutches, etc.

The gearing embodiment according to the invention allows the use of fewer parts to achieve the same function. In the case of a planetary gearing, as is used in the prior art, a motor pinion, six planetary gears, two planet carriers and an internal gear are used. A harmonic drive gearing having the motion-transmission according to the invention requires no more than five parts, namely a wave generator, a tappet gear, a flex ring, an internal gear and a mating gear.

In a refinement of the invention, the grooves are trapezoidal. Owing to the permanent deformation of the toothed band by half the differential of the wave generator, the angle of the individual pins to the center axis also permanently changes, so that not all driving elements are available to the torque transmission. This weakness is minimized by the trapezoidal configuration of the grooves.

A particularly advantageous use of the gearing according to the invention is realized in a digital tachograph for driving a chip card eject mechanism.

The invention is explained in greater detail below with reference to an illustrative embodiment, wherein:

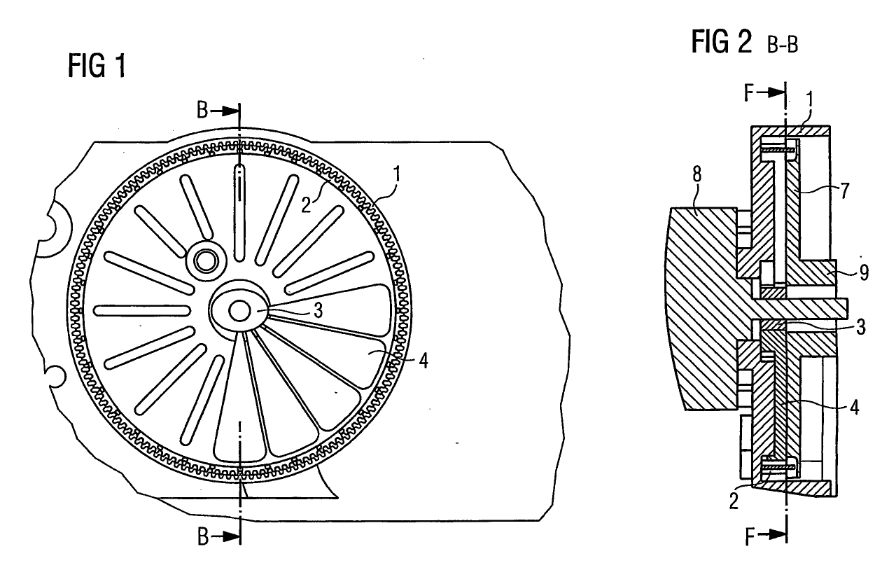

FIG. 1 shows a top view of a gearing according to the invention,

FIG. 2 shows a sectional view through the gearing of FIG. 1,

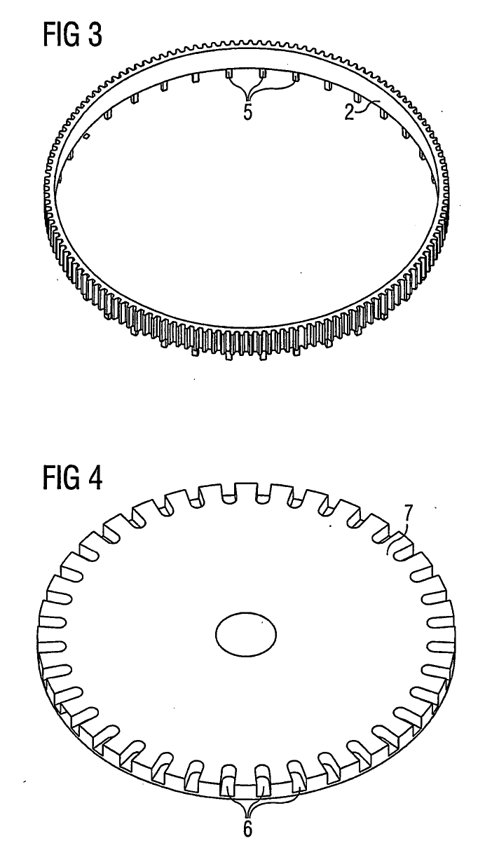

FIG. 3 shows a three-dimensional representation of the flexible toothed band,

FIG. 4 shows a three-dimensional representation of the mating gear,

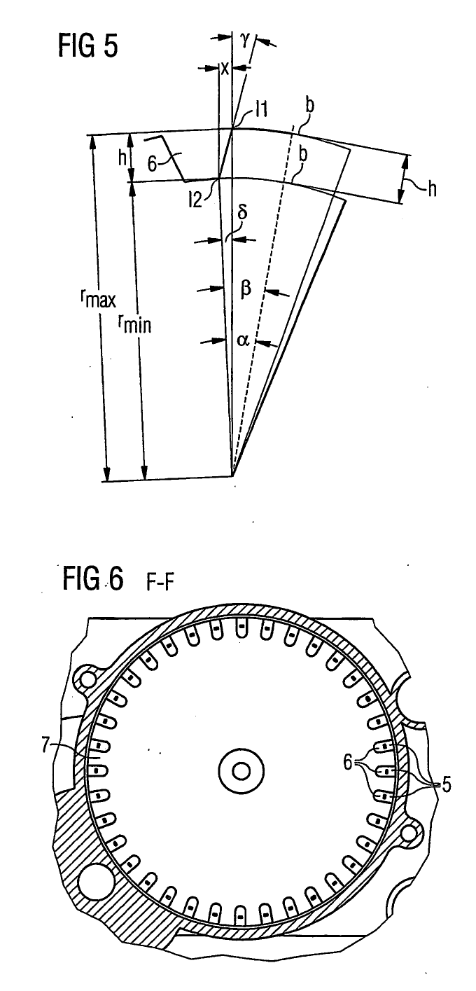

FIG. 5 shows a sectional view through the mating gear, with driving pins engaging therein,

FIG. 6 shows a detailed representation of the geometric configuration of the driving pins,

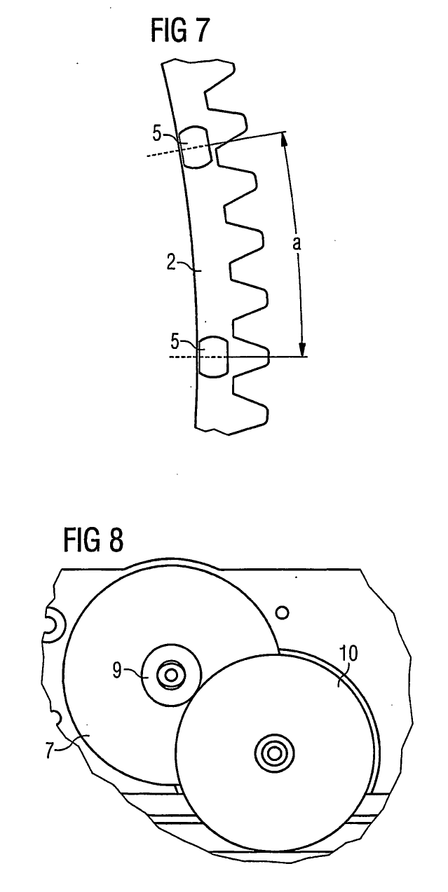

FIG. 7 shows a representation for calculating the trapezoidal shape of the grooves, and

FIG. 8 shows a bottom view of the gearing according to the invention of FIGS. 1 and 2, with the mating gear and further power take-off elements.

FIG. 1 shows a top view of the gearing according to the invention. On the outside there is located a fixed internal gear 1, in whose toothing, on the inner side, a flexible toothed band 2, the so-called flex ring, engages. The flex ring 2 is seated on a tappet gear 4, not all tappet elements of the tappet gear 4 being represented in FIG. 1. The tappet elements of the tappet gear 4 can be made in one piece, so that the tappet gear 4 constitutes only a single part and is thus easy to handle. Nevertheless, the tappet elements must be mutually movable. The tappet gear possesses a central recess, into which a wave generator 4 having an elliptical contour juts. The wave generator 3 is rotatably mounted and connected to a drive, so that, when the wave generator 4 is rotated, transverse waves are generated, which are transmitted to the tappet elements of the tappet gear 4. The transverse waves are supported via the flex ring 2 against the internal gear 1. The flex ring 2 and the internal gear 1 possess intermeshing teeth, the flex ring 2 having fewer teeth than the internal gear 1. When the transverse waves are passed through, this results in a displacement of the flex ring relative to the internal gear 1. For a motion of the flex ring 2 relative to the internal gear 1 to be possible, the radii of the internal gear 1 and of the flex ring 2 must be suitably coordinated.

FIG. 2 shows a sectional view through the gearing of FIG. 1. In this case, a drive 8 can additionally be seen, which drives the wave generator 3 via a shaft. In addition to this, in FIG. 2, a mating gear 7 can be seen, which is driven by the flex ring 2 in the manner described below. For the relaying of the motion of the mating gear 7, a gearwheel 9 is shaped on the latter, which, in turn, can cooperate with another gearwheel. It is likewise evident in FIG. 2 that the flex ring 2 is configured such that it can engage in the mating gear 7.

The flex ring 2 of the gearing of FIG. 1 and FIG. 2 is represented in FIG. 3. On a lateral face of the flex ring 2, in this case on the lower side, driving pins 5 are shaped. Owing to the low thickness of the flexible structural part, the pins on the flex ring 2 turn out to be very small. A high number of pins 5 shall therefore be provided. Moreover, as many as possible should be engaged with the mating gear 7 in order reliably to transmit the torque. Since the flex ring 2 undergoes a deformation amounting to the height differential of the wave generator 3, the driving pins 5 must additionally be able to move radially in the mating wheel 7 by this measure.

The driving pins 5 are therefore engaged in the mating wheel 7 in such a way that the driving pins 5 engage in radially running grooves 6 in the gearwheel 7. In order to optimize the torque transmission between the flex ring 2 and the mating ring 7, this problem arising through the deformation of the flex ring, the grooves can be of trapezoidal configuration. Although this is not envisaged in the embodiment of FIG. 4, it does represent an advantageous refinement.

The calculation of trapezoidal grooves is represented below with reference to FIG. 5. Here, the arc of the flex ring 2 is regarded as a circle, in the maximum and minimum position, respectively.

In FIG. 5, “h” is the differential of the wave generator 3, which is dependent on the used ellipse of the wave generator. The differential h is here derived from half the difference between the maximum and minimum radius. This difference is referred to as the stroke. The radius row is the radius of the internal gear in the “valleys” between the teeth. The radius rₘᵢₙ is the radius of the internal gear, minus the stroke h. The angle α is calculated at α=360°/number of driving pins 5. The radian measure b is calculated at b=α*π*rₘₐₓ/180°. The radian measure is equal in respect of both operating states, since the distance apart of the driving pins 5 does not change. The angle θ works out at β=b*180°/(π*rₘᵢₙ). This produces the angular difference δ=β−α. The difference x between the outer edge 11 of the groove 6 and the inner edge 12 of the groove 6 on a circular arc is calculated at x=tan δ*rₘᵢₙ. This produces the trapezoidal angle γ with tangent γ=x/h.

In FIG. 6, a section through the plane F-F (compare FIG. 2) is represented. There it can be seen that all the driving pins 5 engage in grooves 6 in the mating wheel 7.

FIG. 7 shows the arrangement of the driving pins 5 on the lateral face of the flex ring 2. “a” is here the distance between the pins 5 and is obtained from the circumference of the flex ring divided by the number of driving pins 5.

From FIG. 8 it is apparent how the motion of the mating wheel 7 can be transmitted. The shown illustrative embodiment, a gearwheel 9 is shaped on the mating wheel 7, which gearwheel engages in a further gearwheel 10. A further speed change can in this case be realized.

In the shown illustrative embodiment, the drive shaft and the power take-off shafts lie on the same axis. An offsetting of the drive shaft and power take-off shaft can, however, be equalized, for example for the balancing of tolerances. It is even possible to offset the drive shaft and the power take-off shaft already between the flex ring and the mating gear. This works, however, only in the transmission of low torques, since here only a small number of driving pins are engaged with grooves in the mating wheel. In a more far-reaching embodiment, a speed change mechanism could be built in according to the planetary gear principle. In this case, not even the drive shaft and the power take-off shaft would then need to stand in one direction, i.e. in parallel, but could optionally be disposed at an angle to one another.

1. A gearing comprising
a fixed, internally toothed internal gear,
an annular, flexible toothed band arranged so as to engage with the toothing of the internal gear, the toothed band having fewer teeth than the internal gear, and
a rotatable wave generator arranged to transmit a force to the toothed band via a tappet gear such that a relative motion of the toothed band with respect to the internal gear results from a rotation of the wave generator, and
a mating gear, and driving pins shaped on a lateral face of the toothed band and arranged to engage in recesses in the mating gear.

2. The gearing according to claim 1, wherein axes of the wave generator and of the mating gear are parallel, and in that the recesses in the mating gear are radially extending grooves.

3. The gearing according to claim 2, wherein the grooves are trapezoidal.

4. The gearing according to claim 1, wherein the gearing components are plastic injection-molded parts.

5. (canceled)
